(19) United States
(12) Patent Application Publication
(10) Pub. No.: US 2014/0130324 A1
(43) Pub. Date: May 15, 2014

(54) METHOD FOR ABUTTING PARTS FORMED, AT LEAST IN PART, AS HOLLOW PROFILES

(71) Applicant: Jean-Francois Dagenais, Cassis (FR)

(72) Inventor: Jean-Francois Dagenais, Cassis (FR)

(73) Assignee: SERIMAX, Mitry-Mory (FR)

(21) Appl. No.: 14/130,195

(22) PCT Filed: Jun. 28, 2012
(86) PCT No.: PCT/EP12/62547

§ 371 Date: Dec. 30, 2013

(30) Foreign Application Priority Data
Jul. 1, 2011 (FR) 11/02078

(51) Int. Cl. B23P 19/04

(52) U.S. Cl. CPC B23P 19/04
USPC 29/407.01

(57) ABSTRACT

To abut hollow profiled parts, at least two frames includes actuators distributed in an equivalent manner to one another. Each actuator includes a portion which can be displaced in a plane common to the other actuators of the frame so as to project from the frame; the frames are each positioned in an end region of a respective part. The equivalent actuators are mutually opposed; the mobile portions of the actuators of one frame and of the actuators of the other frame are displaced into respective working positions, in which they exert forces on the wall of their respective part so that the end regions of these parts match one another; the parts are fixed to one another in their respective end regions.

The invention relates to a method for abutting parts, in particular parts having end regions in the form of hollow profiles.

The invention will be described in the specific context of ducts formed from tubes or piping, sometimes called a ‘pipeline’. However, the invention is not limited to this field.

Such ducts are used in particular to transport drinking water, crude oil or gas.

They are formed by abutting tubes. In practice, one end of an additional tube is positioned at the free end of the leading tube of a duct portion already formed, the additional tube is connected to the leading tube and this process is repeated until a duct of desired length is obtained.

In this instance, ducts formed using tubes of large diameter, typically between 48 and 200 inches are of particular interest. For tubes of this type, the positioning and connection procedures are particularly difficult.

These procedures involve bringing the additional tube towards the leading tube of the duct, positioning the ends of these tubes relative to one another and holding the tubes in this relative position during the time it takes to connect them. For example, the tubes may be connected by means of one or more weld beads, at least so as to make the join between these tubes tight.

However, tubes of large diameter are of a considerable weight and size and exhibit low rigidity owing to a low ratio of thickness to diameter.

FR 2 887 164 discloses a device for centring and clamping tubular parts, such as tubes for forming pipeline-type conduits.

This device comprises an elongate cylinder, around the outer periphery of which clamping shoes are distributed in two rings spaced from one another along the longitudinal axis of the cylinder. The clamping shoes can be displaced radially from a position in which they disappear inside the cylinder into a position in which they project from the cylinder until they contact the respective inner walls of the leading tube of the duct and of the additional tube.

The device comprises a cam actuation system which converts a displacement of the plates in the longitudinal direction of the cylinder into a displacement of the shoes in which they move a little like an umbrella mechanism.

Although this device is satisfactory on the whole, it is difficult to transfer to tubes of large diameter. Owing in particular to the significant size of the cylinder, the device would in fact become very heavy and therefore difficult to handle. Furthermore, it would take up the entire cross-section of the duct, thus preventing any personnel or equipment from passing from one part of the duct to another.

Lastly, this device is limited to the clamping and mutual centring of leading and additional tubes.

The tubes to be abutted often, indeed always, have defects of shape, particularly of circularity, which make positioning and connection procedures even more difficult.

As a result, connection by means of welding, adhesion or force-fit for example is virtually only possible to achieve manually, it being necessary for an operator to deal with the different defects of shape and to compensate for them.

The object of the invention is to improve the existing situation.

A method for abutting parts formed, at least in part, as hollow profiles is proposed, in which first and second actuators each comprising a mobile portion are provided, the first actuators being mounted on a first common frame in such a way that their respective mobile portions can move in a common plane by projecting from the first frame, the second actuators being mounted on a second common frame in an equivalent manner to the first actuators; the first frame is positioned in an end region in the form of a hollow profile of a first part and the second frame is positioned in an end region in the form of a hollow profile of a second part in such a way that the equivalent actuators of the first and second frames are mutually opposed; the first actuators and the second actuators are controlled so as to displace the mobile portions thereof into respective working positions in which the mobile portions of the first actuators exert forces on the wall of the first part whereas the mobile portions of the second actuators exert forces on the wall of the second part so that the end region of the first part and the end region of the second part match one another; the first part and the second part are fixed to one another at their respective end region.

Here, the word “actuator” has its conventional meaning in the art, i.e. a device which is capable to convert an input energy into rotational or linear motion. An actuator in its broadest definition is a device that produces linear or rotary motion from a source of power under the action of a source of control. Within an actuator according to the invention, the energy is directly applied on the part in motion within the actuator which itself applies forces and/or motions, for example on an inner or outer wall of a pipe. There is no mechanical transmission modifying the motion mode, distance, strength or direction between the actuator and the surface against which the actuator apply. Here each actuator is capable to generate a movement and/or a force (mechanical energy) from input energy. Input energy of an actuator according to the invention can be pneumatic, hydraulic or electric for example. That type of actuators comprises the cylinders. However, the invention is not limited to the use of cylinders as actuators.

Optional, additional, complimentary or substitute features of the proposed method are described hereinafter.
When the first actuators and the second actuators are controlled, each of the first or second actuators is controlled in such a way that the mobile portion thereof is in a respective starting position; for each first actuator or each second actuator a force value is measured on the respective mobile portion thereof; a displacement control condition of the first actuators or of the second actuators is evaluated on the basis of a comparison of the measured force values with one or more target force values; if the displacement control condition is verified, the corresponding actuators are controlled so as to displace the respective mobile portions thereof by the same distance; the procedures of measurement of force, evaluation of condition, and conditional control of the actuators are repeated until the displacement control condition is no longer verified.
The evaluation of the displacement control condition includes a comparison of a total value of the measured force values with a target force value.
The evaluation of the displacement control condition includes a comparison of each measured force value with a target force value.
The control of the actuators, the direction and/or the distance of the controlled displacement are determined as a function of the comparison of the measured force values with the target force values.
At least some of the target force values are determined as a function of the yield strength of the first part and/or of the second part in the respective end region thereof.
The target force values correspond to an engagement of the first and/or second actuators with the wall of the first part and/or of the second part respectively.
When the first actuators and second actuators are controlled, the forces exerted by the first actuators are greater than or equal to a force of engagement, and when the first part and the second part are fixed to one another, the second part is pulled so as to rest on the first frame; the second part is abutted against the first part; the first part is connected to the second part, at least in the respective end regions thereof.
When the first actuators and the second actuators are controlled, the forces exerted by the second actuators are greater than or equal to a force of engagement, and when the second part is pulled, the second frame is connected to the first frame with a possibility of relative displacement under the action of additional actuators, said displacement comprising at least a component of translation in a direction substantially perpendicular to at least one of the common planes of displacement of the mobile portions of the first actuators and of the second actuators; the additional actuators are controlled in such a way that the second frame and the second part are pulled relative to the first frame and the first part.
When the second part is pulled, third actuators each comprising a mobile portion are provided, the third actuators being mounted on a third common frame in such a way that their respective mobile portions can be displaced so as to project from the third frame; the third frame is positioned in the second part so as to be distanced from the end region thereof compared to the second frame; the third actuators are controlled as far as a working position in which said third actuators engage with the wall of the second part; the third frame is connected to the first frame with a possibility of relative displacement under the action of additional actuators, said displacement comprising at least a component of translation in a direction substantially perpendicular to at least one of the common planes of displacement of the mobile portions of the first actuators and of the second actuators; the additional actuators are controlled in such a way that the third frame and the second part are displaced relative to the first frame and the first part.
When the first actuators and second actuators are controlled, the forces exerted by the second actuators are close to a simple contact force.
Since the end region of either the first part or the second part is shaped in the form of a collar, when the first actuators and second actuators are controlled the forces exerted by the mobile portions of the first or second actuators are established as a function of the yield strength of the respective end region shaped in the form of a collar, whereas the forces exerted by the mobile rods of the respective other of the first and second actuators correspond to a simple contact force.
When the first and second actuators are provided, the first actuators being mounted on the first frame, a reference position is established for each of them based on a contact position in which their mobile portions thereof each exert a first value of force on the wall of a model part; the second actuators being mounted on the second frame, a reference position of their mobile portion is established for each of them based on a contact position in which said mobile portions exert a force of equal value to said first value of force on the wall of the model part; when the first actuators and the second actuators are controlled, the mobile portions are displaced jointly from their respective reference position. The first force value may correspond to a simple contact with the wall of the model part.
When the first actuators and the second actuators are controlled, the first actuators and/or the second actuators are displaced jointly, step by step, from their reference position.
The reference position of the first and/or second actuators corresponds to a displacement of retraction from their respective contact position, the value of the retraction being substantially equal for all of the first actuators and/or the second actuators.
When the first actuators and the second actuators are controlled, the end region of the first part and the end region of the second part are shaped pseudo-homothetically to one another. The first part comprises a leading tube of a duct formed of tubes, whereas the second part comprises an additional tube.
The first actuators and the second actuators can be controlled individually and independently from each other.

A kit forming a device for implementing the proposed method is also proposed. The kit comprises first and second actuators each comprising a mobile portion, a first frame and a second frame, the first actuators being mounted on the first frame in such a way that their respective mobile portions can be displaced in a common plane projecting from the first frame, the second actuators being mounted on the second frame in an equivalent manner to the first actuators on the first frame.

Optional, additional, complimentary or substituting features of the proposed kit are described hereinafter.
The kit also comprises memory storing, for each of the first actuators, a reference position of the mobile portion thereof corresponding to a first value of force on the wall of a model tube, and for each of the second actuators a reference position corresponding basically to the first force value of the first equivalent actuator thereof.
The kit also comprises third actuators, each comprising a mobile portion, and a third frame, the third actuators being mounted in common on the third frame in such a way that their respective mobile portions can be displaced by projecting from the third frame.
The kit further comprises at least one device for connecting, with relative displacement, the second frame or third frame on the first frame, the mounting device comprising additional actuators, under the action of which the second frame or the third frame can be pulled towards the first frame.

Further features and advantages of the invention will become clear upon examination of the detailed description below and the accompanying drawings, in which:

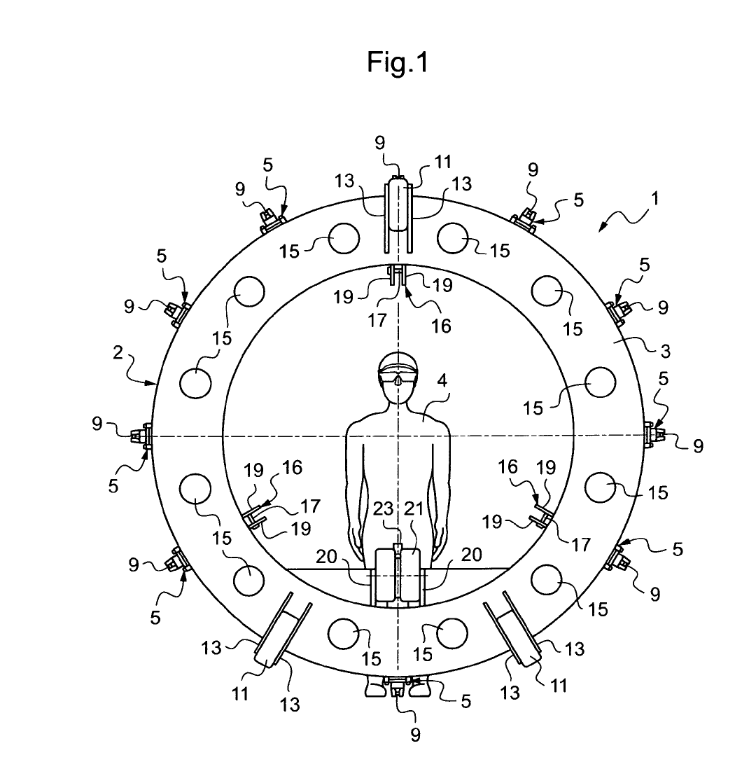

FIG. 1 is a front view of a tube support;

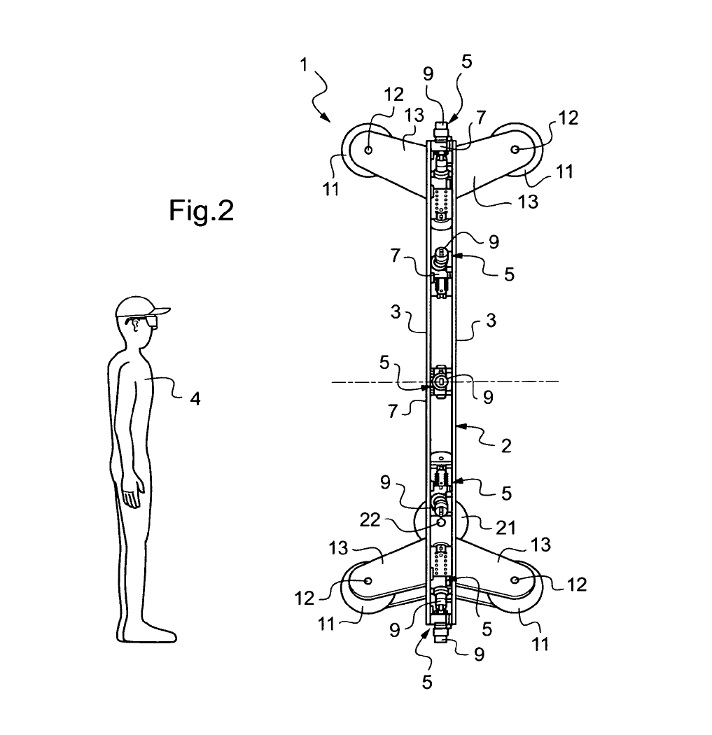

FIG. 2 is a side view of the support of FIG. 1;

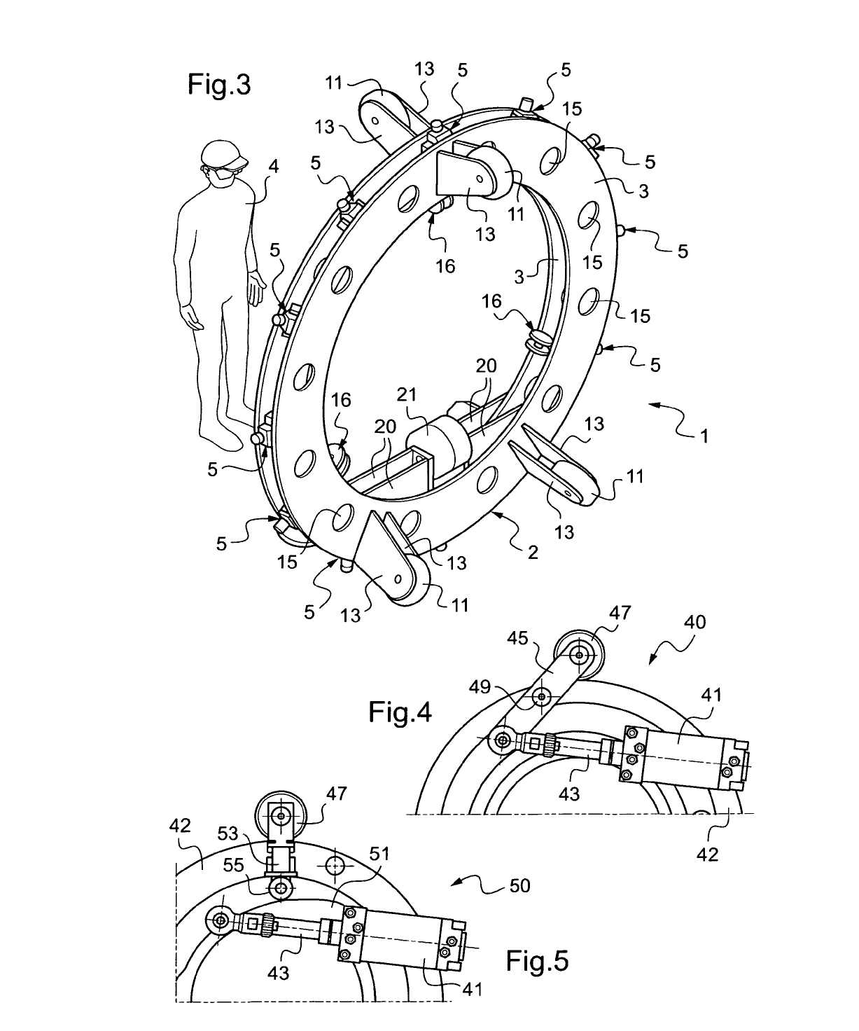

FIG. 3 shows an isometric perspective view of the support of FIG. 1;

FIG. 4 shows a first variation of an actuator for the support of FIG. 1;

FIG. 5 shows a second variation of an actuator for the support of FIG. 1;

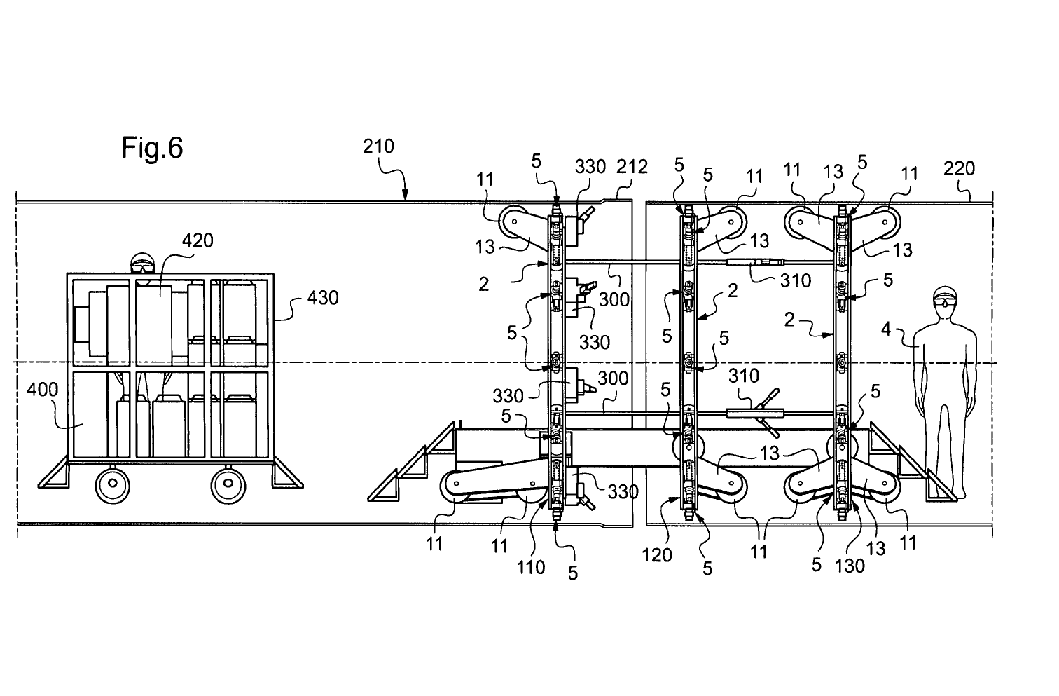

FIG. 6 is a longitudinal sectional view of two tubes pre-positioned relative to one another before mutual abutment;

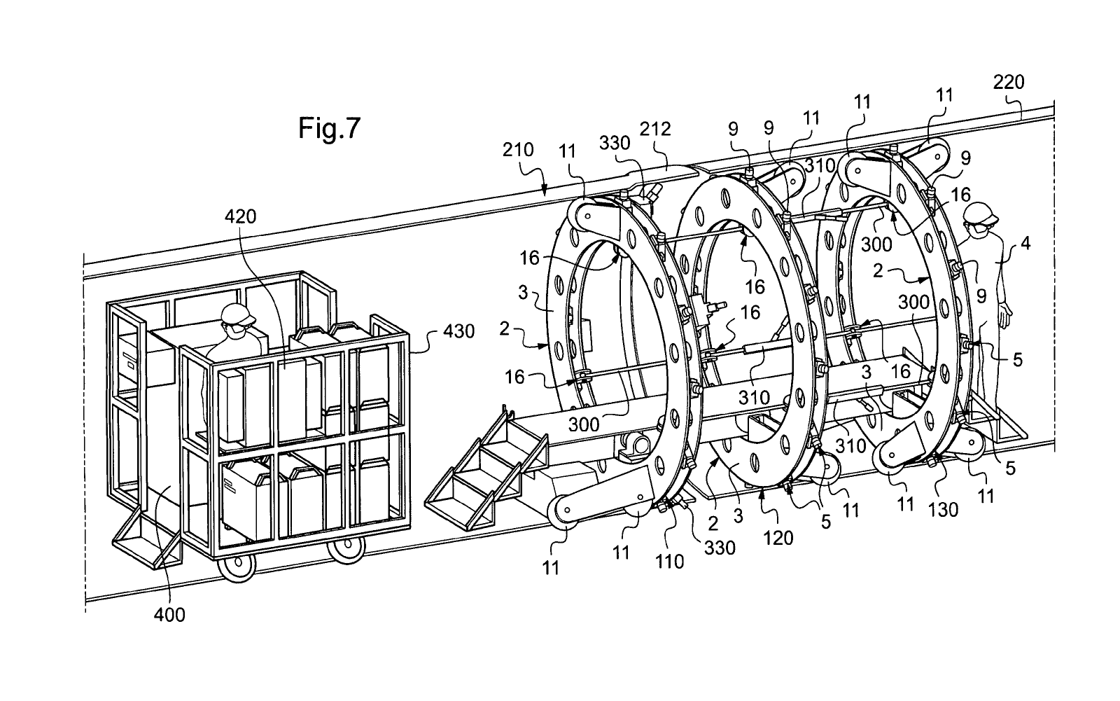

FIG. 7 is an isometric perspective view, cut away in part, corresponding to FIG. 6;

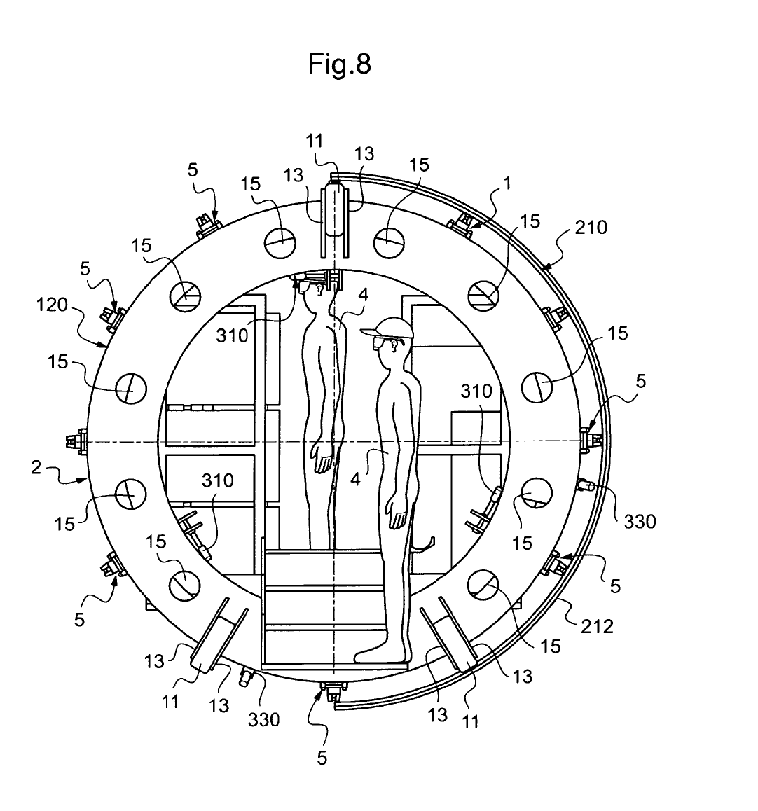

FIG. 8 is a side view corresponding to FIG. 6;

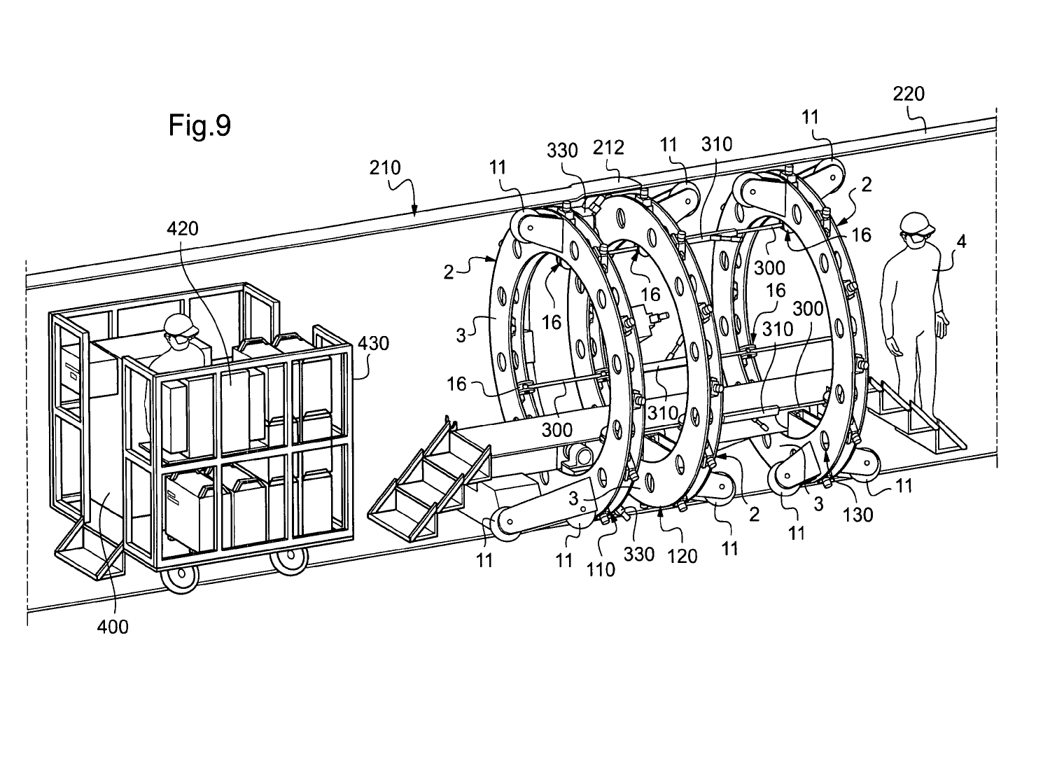

FIG. 9 is a longitudinal sectional view of the tubes of FIG. 6 after mutual abutment;

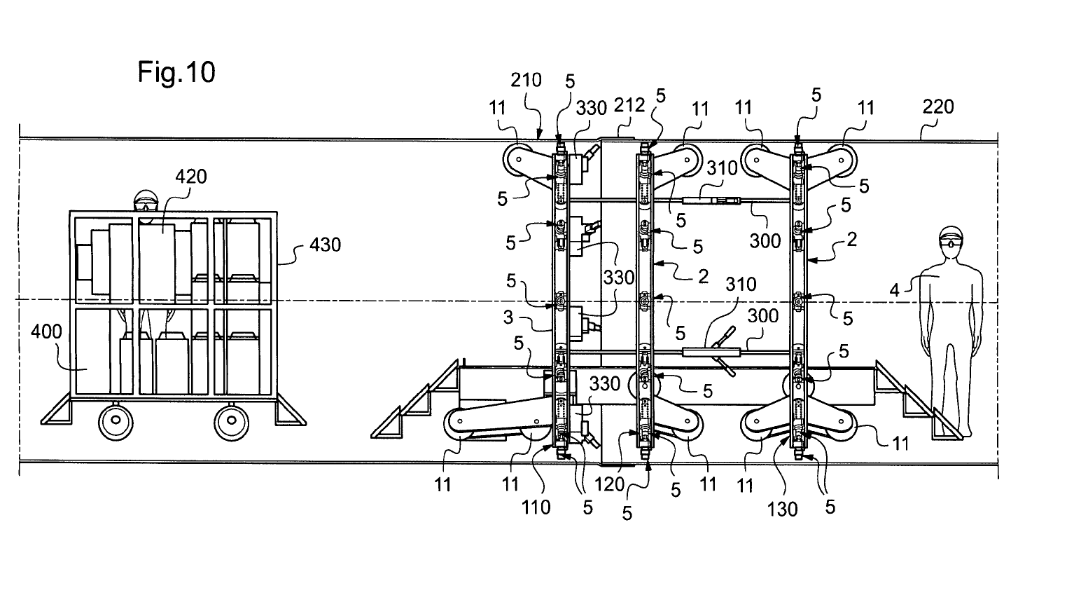

FIG. 10 is an isometric perspective view, cut away in part, corresponding to FIG. 9;

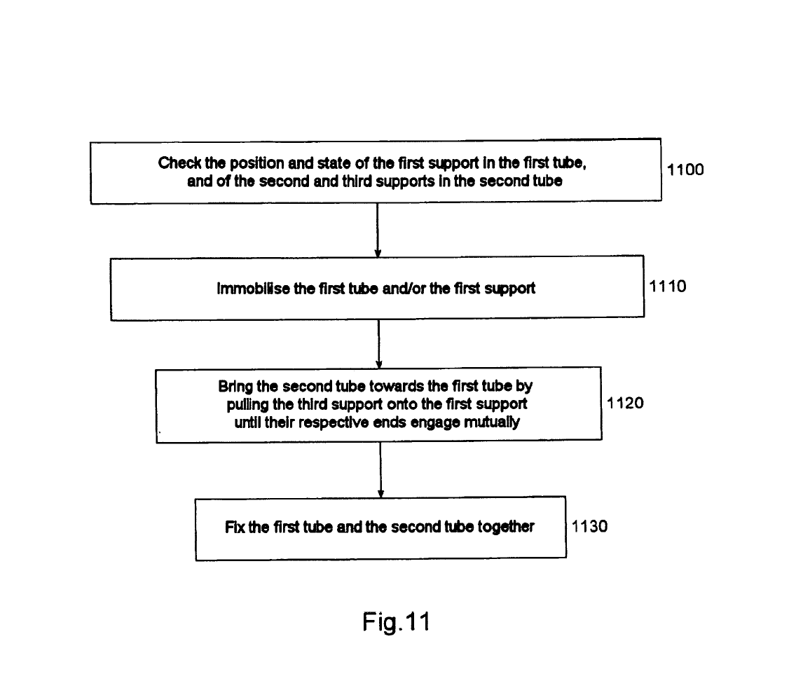

FIG. 11 is a flow chart illustrating an abutment process of two tubes;

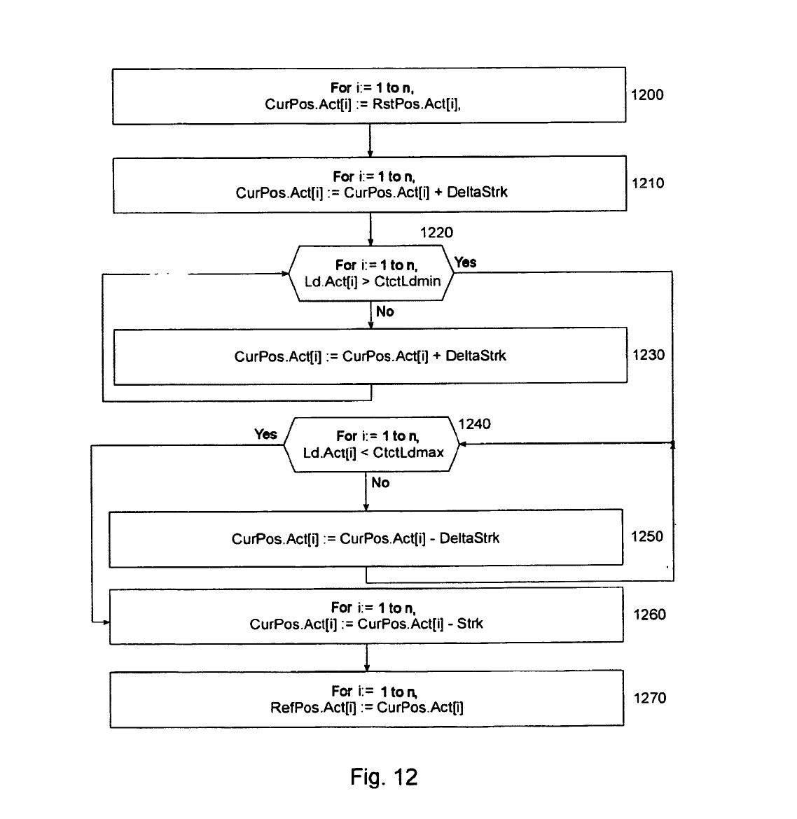

FIG. 12 is a flow chart illustrating a control sequence of actuators corresponding to a calibration of tube supports;

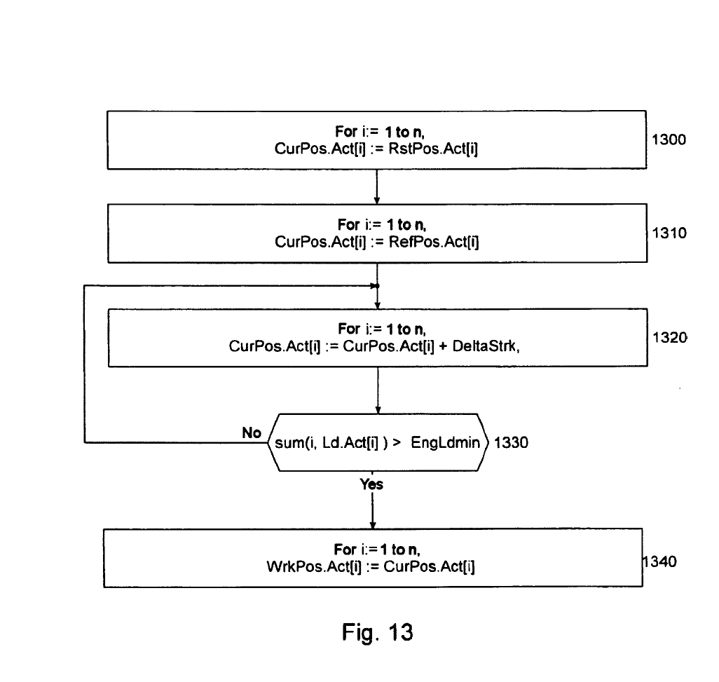

FIG. 13 is a flow chart illustrating a control sequence of actuators corresponding to an engagement of a tube support;

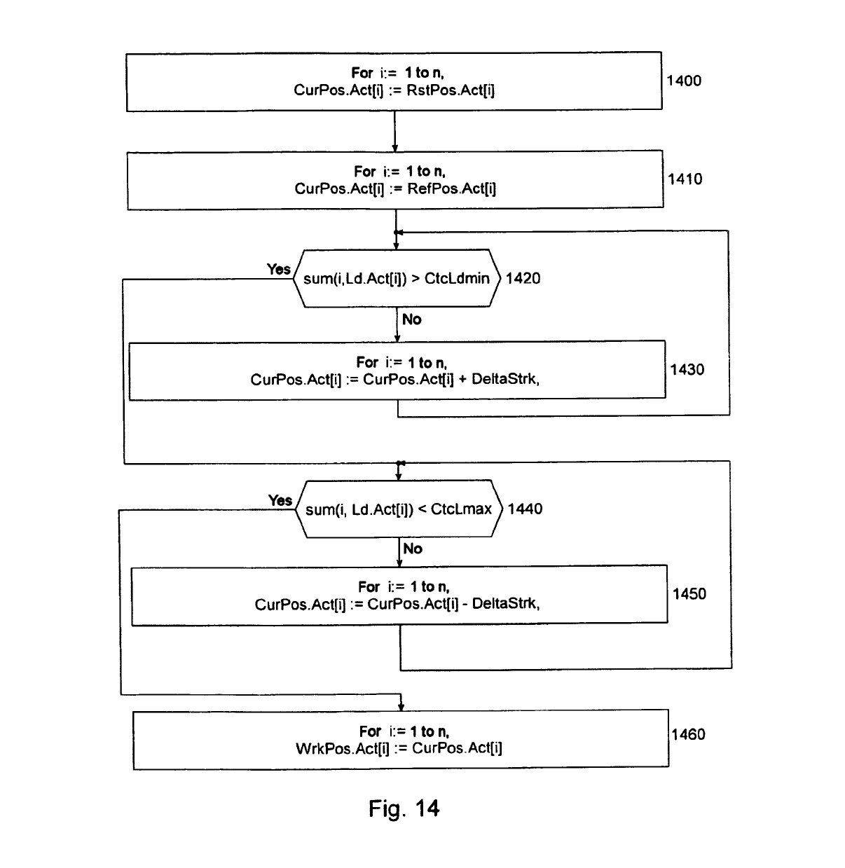

FIG. 14 is a flow chart illustrating a control sequence of actuators corresponding to a shaping by a tube support;

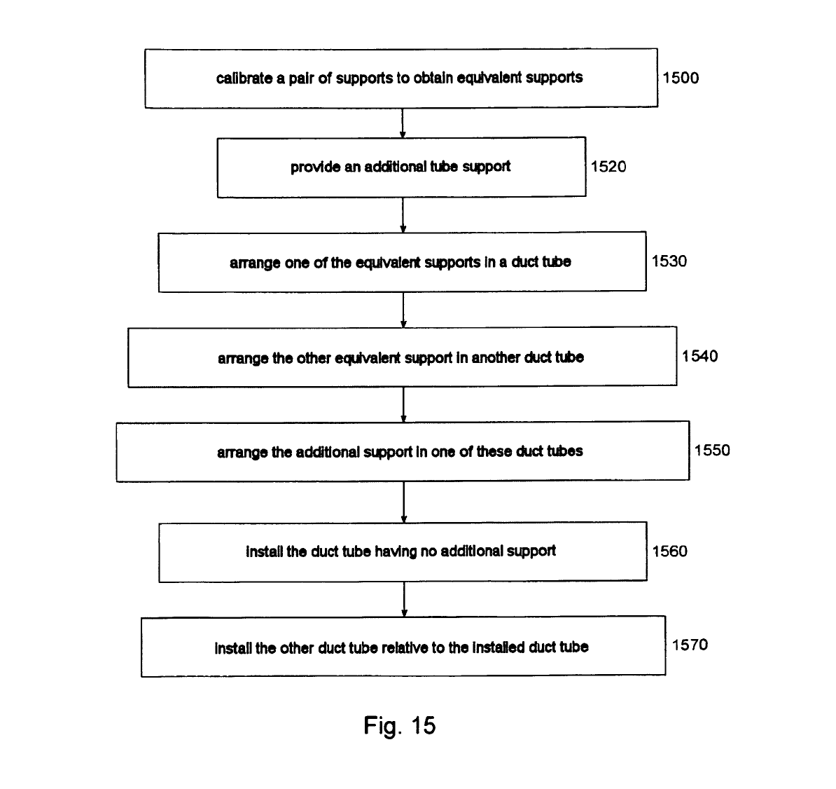

FIG. 15 is a flow chart illustrating a pre-positioning of two tubes to be abutted according to a first implementation;

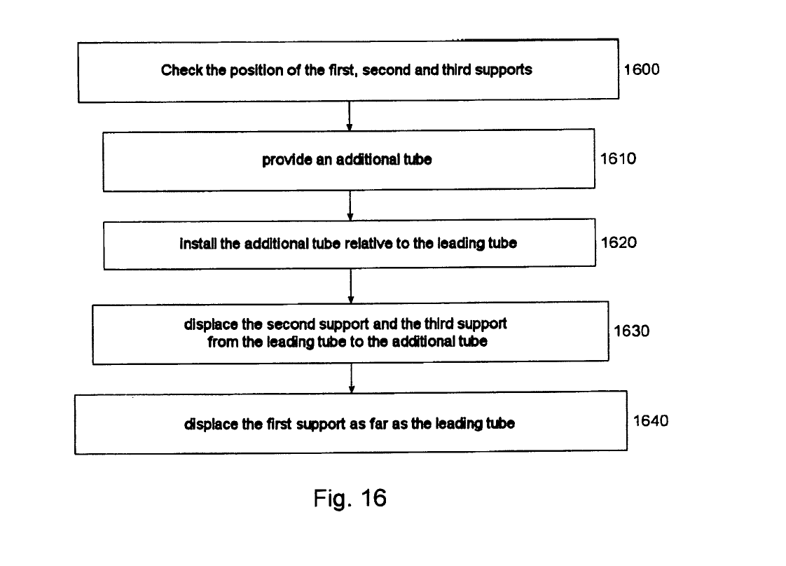

FIG. 16 is a flow chart illustrating a pre-positioning of two tubes to be abutted according to a second implementation;

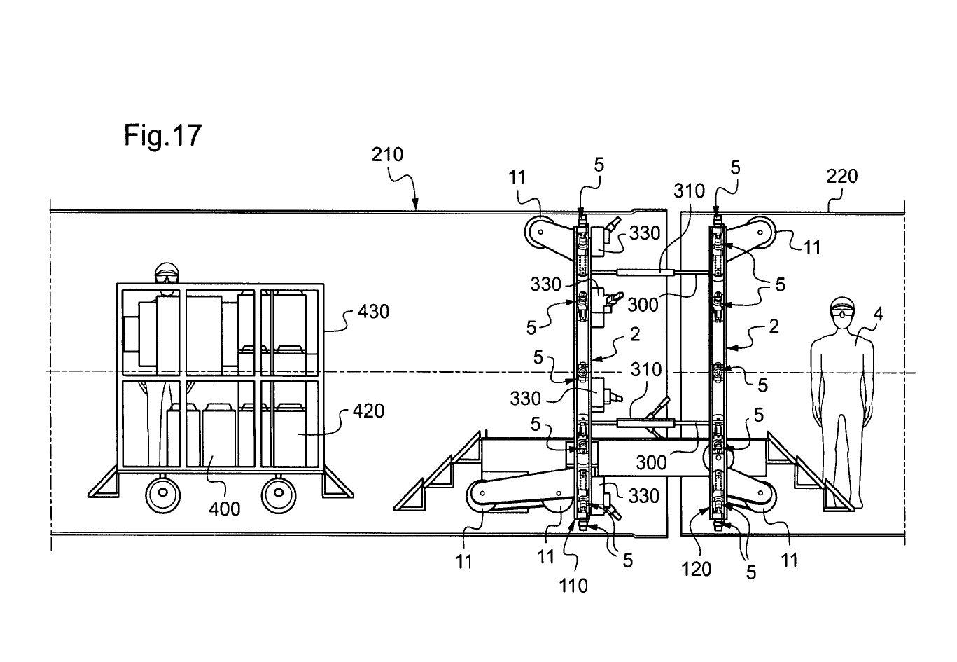

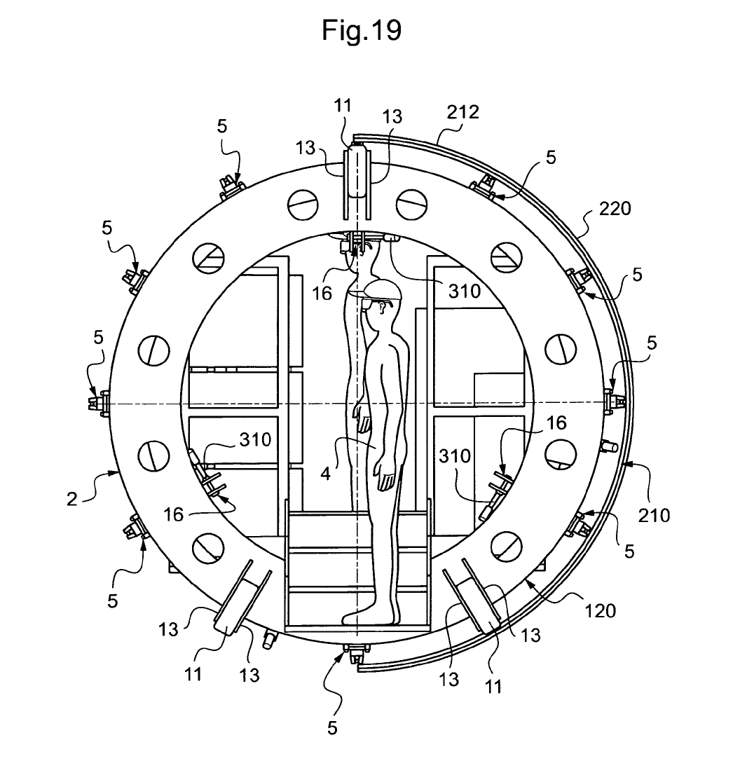

FIGS. 17 to 21 are views similar to FIGS. 6 to 10 respectively for a second embodiment of the invention.

The accompanying drawings include elements of a definite nature and may therefore not only supplement the invention, but may also contribute to the definition thereof, where appropriate.

Reference is made to FIGS. 1 to 3, which show a support 1 for a tube, said support also possibly being called a ‘ramp’.

The support 1 comprises a frame 2 comprising a pair of similar end plates 3 in the respective shape of a ring. The end plates 3 are mounted rigidly against one another concentrically.

The support 1 also comprises a plurality of actuators mounted on the frame 2, in this case in the form of actuating cylinders 5. In this case the actuating cylinders 5 are distributed uniformly in an angular manner over the frame 2 in the form of a ring.

Each actuating cylinder 5 has a generally parallelepiped body 7, from which a slidingly mobile rod 9 projects. Each actuating cylinder 5 is arranged in such a way that the respective rod 9 thereof can be displaced, in a direction which is substantially radial relative to the frame 2, beyond the outer periphery of the end plates 3, in particular by becoming distanced from the centre of the end plates 3 compared to the position illustrated in FIGS. 1 to 3.

The rods 9 of the actuating cylinders 5 can move in a common plane so as to project from the frame 2. This plane is parallel to the primary plane of each of the end plates 3 and is located between these primary planes.

Each end plate 3 rests against a large respective face of the body 7 of each of the actuating cylinders 5 in a planar manner. Each body 7 thus forms a crossmember or strut which is used for mutual joining of the end plates 3. The structure of the support 1 is thus simple to produce and quite light.

The actuating cylinders 5 have a reinforced structure which allows them to withstand significant radial forces on the rod 9. The radial forces are directed orthogonally to the longitudinal axis of the rod 9. Conventional actuating cylinders are normally designed so as to withstand a radial force between 1 and 5% of the longitudinal force. In this case the actuating cylinders 5 are designed so as to radially withstand forces of up to 20% of the thrust force which the actuating cylinder 5 may generate in the direction of the longitudinal axis of the rod 9. This value may be adapted as a function of the application, in particular of the coefficient of friction between the end of the rod 9 and the wall of the tube. A reinforced structure may be formed by providing a long guide for the rod 9 in the actuating cylinder body 7, as well as a diameter of said rod greater than conventional actuating cylinders.

In this case the support 1 is equipped with twelve actuating cylinders 5, but the number of actuating cylinders equipping the support 1 may vary, in particular as a function of the nominal diameter of the tubes for which said support is intended and/or the thickness of said tubes.

A respective position sensor (not shown) is allocated to each of the actuating cylinders 5 and delivers a signal indicating the position of the rod 9 relative to the body 7 of the actuating cylinder 5 in the direction of the longitudinal axis of said rod 9. It is possible to deduce values of displacement of the rod 9 from position data.

A respective force sensor (not shown) is also allocated to each of the actuating cylinders 5 and delivers a signal indicating a value resulting from the forces exerted longitudinally on the rod 9. Additional force sensors may optionally be allocated to at least some of the actuating cylinders 5 to measure a value resulting from forces exerted radially on the rod 9.

In this case each force sensor comprises two pressure sensors, each arranged so as to deliver a signal representative of the pressure prevailing in a respective chamber of the actuating cylinder 5. The resultant of the forces exerted longitudinally on the rod 9 is deduced from these pressure values. In addition to the intensity of the forces on the rod 9, it is thus also possible to monitor the pressure in each of the chambers of the actuating cylinder 9, and where appropriate to deduce therefrom a fluid leak (drop in pressure in one of the chambers) or a piston blockage (immobility of the rod 9 in response to a displacement command).

In a variation, a force gauge may be mounted in each case on the end of a rod 9 between a contact portion of the rod and the end of a main portion of the rod in order to measure the longitudinal forces on said rod 9.

Each actuating cylinder 5 is supplied in this instance by a respective solenoid valve of the pulse type which can be controlled electrically in such a way that the rod 9 of the actuating cylinder 5 moves relative to the body 7 in a single step in the longitudinal direction of said rod upon each electrical impulse. In this case the solenoid valves are able to supply a pressure of approximately 700 bar. Solenoid valves of the NBVP16GX24 model by HAWE may be used. In a variation, the solenoid valves may be of the proportional type, for example the WV700-6-4/3-E-24-P-A00 model by BIERI.

Optionally, the actuating cylinders 5 support, at the free end of their respective rod 9, a roller (not shown) mounted freely. In this case, one of the actuating cylinders 5 may be devoid of a roller so as to establish a reference position of the support in the tube.

Each of the end plates 3 supports wheels 11 mounted rotatably via a shaft 12, of which the longitudinal axis lies in a plane parallel to the primary plane of the end plates 3. Each wheel 11 is mounted on a pair of tabs 13 which project from the main surface of a respective end plate 3, said surface opposing the neighbouring end plate 3. Each pair of tabs 13 forms what is known as a clevis within the field.

Each end plate 3 is pierced with holes 15 to reduce the weight of the support 1.

Each wheel 11 projects, at least in part, beyond the outer edge of the end plates 3. The wheels 11, in this case three per end plate 3, are arranged in such a way that two of them are symmetrical about a line of diameter passing through the third wheel, and form between them an angle to the centre of the ring close to 60°. Together with the equivalent wheels of the other end plate 3, these two wheels 11 form a rolling system of feet which makes it possible for the support 1 to hold itself in a tube, perpendicular to the longitudinal axis thereof.

The support 1 comprises latches 16 each comprising a journal 17 of which the axis is in a plane parallel to the primary plane of the end plates 3 and located therebetween inside the ring. Each journal 17 is supported between a pair of tabs 19 which project radially towards the inside of the ring and are connected to the respective end plate 3.

The latches 16 are distributed, in this case uniformly, over the inner edge of the support 1.

The support 1 comprises three latches 16 in this instance.

The support 1 further comprises a rotating roller 21 mounted on a shaft 22 supported by a pair of tabs 20 which together form a clevis, of which the axis of rotation lies in a plane parallel to the primary planes of the end plates 3, inside the ring.

The roller 21 has a peripheral groove 23, in a central position, which extends in a circular manner.

In this configuration the support 1 generally resembles a ring of which the outer diameter is close to the inner diameter of the tubes for which it is intended. This allows an operator 4 to pass through.

FIG. 4 shows an actuator 40 which may equip the support 1, either alternatively or additionally to the actuating cylinders 5, in a variant embodiment of this support 1.

The actuator 40 comprises an actuating cylinder 41 attached to a support 42 which may be part of the support 1. The end of the rod 43 of the actuating cylinder 41 is mounted rotatably on one end of a connecting rod 45. The opposite end of said connecting rod 45 carries a roller 47 mounted freely. A journal 49 ensures rotatable mounting of the connecting rod 45 on a portion of the support 42. Actuation of the actuating cylinder 41, for example so the rod 43 thereof is retracted, pivots the connecting rod 45, thus causing a displacement of the end thereof carrying the roller 47 via a movement including a virtually radial component, for example so as to distance the roller 47 from the support. Conversely, extension of the rod 43 causes the roller 47 to be brought towards the support 42.

FIG. 5 shows an actuator 50 which can equip the support 1, either alternatively or additionally to the actuating cylinders 5 and/or the actuators 40. The rod 43 of the actuating cylinder 41 is mounted rotatably on a cam 51, rotation of which causes the substantially radial displacement of an additional rod 53, mounted slidingly on the support 42. One end of the additional rod 53 carries a roller 47 mounted freely in rotation. The opposite end of said additional rod 53 is in pointwise contact with the cam 51 via an additional roller 55 mounted freely in rotation. Rotation of the cam 51 in a first direction distances the roller 47 from the support 42 owing to the contact between the cam 51 and the additional rod. Rotation of the cam 51 in the opposite direction brings the roller 47 towards the support 42 owing to the return means which may in particular take the form of springs and/or a groove enclosing the opposite end of the additional rod 53.

Reference is made to FIGS. 6 to 8.

It can be seen that a first tube 210 and a second tube 220, which are similar, each have an end portion shaped in the form of a collar 212 (the collar 212 of the second tube 220 cannot be seen in these figures) and an end portion longitudinally opposite said collar 212 of nominal diameter of the tube (the end portion of nominal diameter of the first tube 210 cannot be seen in these figures).

These similar tubes have the same general shape, nominal dimensions and tolerances which are identical, or at least compatible with one another. They may differ from one another in particular by their defects of shape, for example of circularity or planarity of their end faces or else their length.

The first tube 210 and the second tube 220 have a low nominal thickness, for example between half an inch and four inches, typically approximately one inch, compared to their nominal diameter, which is generally between 48 and 200 inches. As a result, the tubes 210 and 220 are quite flexible, which complicates the abutment thereof, in particular the fixing thereof to one another. In the example shown, the tubes 210 and 220 have a nominal diameter close to 108 inches. The considerable nominal diameter of these tubes 210 and 220 implies dimensional differences from the nominal data which may be significant and further complicate the abutment of said tubes. Owing to their dimensions, the tubes 210 and 220 deform easily, in particular under the action of gravity or after prolonged storage (sagging, creep).

Tubes of this type, which are usually formed by rolling and welding sheet metal and then by cutting, have defects of shape (circularity, planarity of their end faces, diameter value) which further complicate the joining of their ends, in particular the mutual positioning and fixing thereof.

In the specific case shown in this instance an end portion of the second tube 220 must also be engaged in the collar 212 of the first tube 210—a procedure which is complicated by the flexibility of the first tube 210 and of the second tube 220 and by the defects of shape thereof, in particular of circularity.

One end of the first tube 210, the end which corresponds to the collar 212, is arranged opposite the end of the second tube 220 which is of the nominal diameter of said second tube 220. These ends are distanced from one another, in particular in a direction which basically corresponds to the longitudinal direction of these tubes: the end of the second tube 220 is arranged outside the collar 212 of the first tube 210. The first tube 210 and the second tube 220 are arranged in a state of mutual pre-positioning compared to the final position which they will adopt in the tube duct.

The first tube 210 and the second tube 220 are held individually in this position under the action of their own weight and/or each supported on a pair of battens (not shown) and/or via the lateral walls of a trench hollowed out for the duct, and/or by any other means compatible with that which will be described hereinafter.

A first support 110 of the type of the support 1 is arranged inside the first tube 210, in the vicinity of the end of this tube which is close to the second tube 220. In this case, the first support 110 is arranged in the vicinity of the collar 212. Advantageously, the first support 110 is positioned in such a way that the distance separating the actuating cylinders 5 over the length of this first tube 210 from the start of the collar is less than 300 millimetres, even less than 200 millimetres and even less than 100 millimetres if possible. In other words, the first support 110 is arranged closest to the point of future fixation. Depending on the applications, in particular the significance of manufacturing tolerances over the dimensions of the tubes 210 and 220, it is possible to distance the first support 110 a little further away.

Initially, the distance between the proximal ends of the tubes 210 and 220 is quite unpredictable. Typically, the tubes 210 and 220 are pre-positioned using a hoist, one after the other. The distance is thus approximately 300 millimetres and varies with the skill of the operator. In some cases, it is possible to set a specific distance between the tubes 210 and 220.

A second support 120, in this case similar to the first support 110, is arranged inside the second tube 220 in the vicinity of the end of said tube which is close to the first tube 210. The second support 120 is arranged virtually opposite the first support 110, that is to say that each actuator 5 of the second support 120 is basically aligned with an equivalent actuator 5 of the first support 110 in the longitudinal direction of the tubes 210 and 220. Optionally, at least one of the first support 110 and the second support 120 comprises a retractable roller arrangement (not shown) that can be extended so as to contact the inner surface of a respective tube and permit the support to pivot in a cross section of the tube. A tool for aiding the alignment may be used, such as a laser sight, a rule or a gauge, for example. The second support 120 is advantageously positioned in such a way that the distance separating the actuating cylinders 5 from the end of the tube along the length of the second tube 210 is less than 300 millimetres, even less than 200 millimetres and even less than 100 millimetres if possible. In other words, the second support 120 is also arranged, in the second tube 220, closest to the place of future fixation.

A third support 130 is arranged inside the second tube 220 at a distance from the second support 120 in the longitudinal direction of the second tube 220. For example, the third support 130 is positioned at a distance from the end of the tube of between 1.5 and 2 metres. In this case, the third support 130 is similar to each of the first support 110 and the second support 120.

In this case, welding torches 330 are mounted on the first support 110 and are mobile on an annular rail of which the shape is homothetic to that of the end plate 3 on which it is supported.

An individual power supply unit 400, which may be pneumatic, hydraulic or electric, powers the actuating cylinders 5 of each of the first support 110, the second support 120 and the third support 130. In a variation, one power supply unit may be provided per support, or one power supply unit may be provided per actuating cylinder 5 or sub-group of actuating cylinders 5.

The solenoid valves powering each of the actuating cylinders 5, and the position and force sensors of each of said actuating cylinders are also connected to an electronically assisted control unit 420, which may be semi-manual or completely automatic. The power supply unit 400 and the control unit are installed on a control trolley 430 housed in the first tube 210 and distanced from the second tube 220 compared to the first support 110.

The first support 110 and the third support 130 are connected to one another with the possibility of relative displacement, at least in a direction perpendicular to the primary planes of the respective end plates 3 thereof under the action of actuators, which may be of a mechanical, electric, pneumatic or hydraulic type, controlled manually or electronically. These actuators form pulling means, at least in part.

In this case the first support 110 and the third support 130 are connected to one another by (three) cables 300 which each pass around the journal 17 of a latch 16 of the first support 110 and around that of the latch 16 of the third support 130 which is located opposite.

Each cable 300 is closed in a loop by a respective tensioner 310, manual actuation of which brings the first support 110 and the third support 130 towards one another. In this case the tensioners 310 comprise what is known as a ratchet cable winch or ratchet cable hoist. Additionally or alternatively, actuators of a different type may also be used, for example unguided actuating cylinders and/or ball joint actuating cylinders, chain hoists or pulley winches.

Force sensors may optionally be installed on the pulling means. In particular, this makes it possible to detect any occurrence of shifting.

The first support 110 and the second support 120 are matched: on the one hand the actuating cylinders 5 which equip the first support 110 are mounted on the frame 2 of said support in an equivalent manner to the actuating cylinders 5 which equip the second support 120, and on the other hand reference positions of the end of the rods 9 of the actuating cylinders 5 of these supports are established jointly.

In other words, the reference position of the rods 9 of the actuating cylinders 5 of the first support 110 corresponds to the reference position of the rods 9 of the actuating cylinders 5 of the second support 120, i.e. in this reference position the ends of the rods 9 of the first support 110 and of the second support 120 respectively form the vertices of two virtually identical polygons.

This does not necessarily mean that in this reference position the position of each rod 9 relative to the body of the respective actuating cylinder thereof is the same as the position of the rod 9 of the equivalent actuating cylinder relative to the actuating cylinder body thereof, in particular as a result of manufacturing tolerances of the end plates and assembly play between the actuating cylinders and said end plates.

For each actuating cylinder 5 of each of the supports 110 and 120, the reference position of the rod 9 thereof can be expressed relative to the body 7 or, in a variation, relative to the support or else to any frame of reference attached to the respective support of said rod. The reference positions correspond to a position in which, theoretically, the end of the rod 9 of each of the actuating cylinders 5 of a support should be in contact with the inner surface of a similar tube over the same section.

The reference position of the actuating cylinders may be stored in a memory, for example integrated in the control unit 420.

In FIGS. 6 to 8 the rods 9 of the actuating cylinders 5 of the first support 110 are each arranged in a working position in which they are in contact with the inner surface of the first tube 210. For each actuating cylinder 5, this working position corresponds to an extension in relation to a respective reference position. This extension is basically the same for all the actuating cylinders 5 of the first support 1. The rods of the actuators 5 of the first support 110 thus give a shape to the first tube 210 with a level of pressure such that a longitudinal portion of this tube is shaped.

This shape given to the first tube 210 may be considered to be pseudo-homothetic to the shape adopted when the actuating cylinders 5 are all in the reference position, or reference shape. In this case it is considered that two polygons may be deemed to be “pseudo-homothetic” when they deduct from one another, by the same increase or the same decrease, segments connecting the centre of the polygon to each of the vertices thereof. In other words, a “pseudo-homotheity” is distinguished from a conventional homotheity by the fact that the increase or decrease in question is not proportional to the distance separating the centre of the polygon from the vertex in question, but is identical for all the vertices.

In this case, the actuators 5 form an “engaged” contact between the first support 110 and the first tube 210: the force exerted on the inner surface of the first tube 210 by the rods 9 of the actuating cylinders 5 is such that a radial frictional force is generated which makes it possible to pull the second tube 220 by supporting it on the first support 110, the first tube 210 being immobilised.

The level of pressure to be exerted depends firstly on the mass of the second tube 220, which is generally known, at least approximately. It also depends on the conditions in which the second tube 220 rests, more precisely on frictions between the outer surface of the second tube 220 and the support surface thereof. It also depends on the coefficient of friction between the end of the rods 9 and the inner surface of the first tube 110. By way of first approximation, this longitudinal force can be calculated in such a way that it corresponds to the dead load of the second tube 220, i.e. the sum of the radial forces on the rods 9 of the actuating cylinders 5 of the first support 110 exceeds the dead load of the second tube 220.

The force to be exerted by the actuating cylinders 5 in the longitudinal direction thereof may have to be adapted as a function of a possible covering of the inner surface of the first tube 210.

The rods 9 of the actuators 5 of the second support 120 are each arranged in a respective working position, close to their reference position, in which they together carry out a minimal resilient reshaping of the second tube 220, which basically corresponds to the reference shape, by executing a minimal radial expansion, i.e. by exerting minimal forces. In this working position, the ends of the rods 9 are in a position close to a reference position.

The actuators 5 of the third support 130 are controlled so as to provide an engaged contact between the third support 130 and the second tube 220, i.e. so as to allow the second tube 220 to be moved by pulling the third support 130. For example, these actuators 5 are controlled in such a way that the ends of the rods 9 are expanded radially compared to the reference position thereof. Since this third support 130 is distanced from the end of the second tube 220 to be engaged in the collar 212, it is not necessary for the actuators 5 of the third support 130 to be distributed over said support in a manner equivalent to that of the actuating cylinders of the first support 110 and of the second support 120, nor is it necessary for them to jointly define a shape which is pseudo-homothetic to the reference shape.

The closer the third support 130 is to the first support 110 when the first tube 210 and the second tube 220 are in a state of pre-positioning, the easier it is to connect these supports to one another. However, the third support 130 must be sufficiently distanced from the end of the second tube 220 to be engaged in the collar 212 so as to avoid any additional deformation of the second tube 220 at this end. In addition, since a large number of operators work simultaneously on the same tube between the pre-positioned and in-place states, it is useful to avoid distancing the third support 130 too far from the second support 120 so as to leave a working space between the third support 130 and the end of the second tube 220 distanced from the second support 120, which working surface is sufficiently accessible to all these operators.

In the vicinity of its collar 212, the first tube 210 is expanded radially in accordance with a shape which is pseudo-homothetic to the reference shape. In the vicinity of its corresponding end, the second tube 220 is shaped in accordance with this reference shape or a pseudo-homothetic shape with a ratio close to one. Owing to this, it is virtually ensured that the second tube 220 can penetrate inside the collar 212 of the first tube 210.

Normally, the tubes of the type of the tubes 210 and 220 have manufacturing tolerances conforming to API 5L (version 43, in particular tables 7 to 9). This API does not mention tolerances for the collar 212. These tolerances are generally established as a function of the intended application and the know-how of the manufacturer. In order to join these tubes, in particular by welding, it is important that there is no gap between the outer surface of the tube 220 and the inner surface of the tube 210, or that this gap is constant over the edge of the region of fit, which is not possible in practice. This is why, in the field, it is normal to determine as precisely as possible the inner diameter of the collar 212: for example this inner diameter of the collar 212 is equal to the outer diameter of the tube 220, and has the same tolerances. Sometimes these tolerances are determined in such a way that the inner diameter of the collar at the maximum tolerance is equal to the outer diameter of the tube 220 at the minimum tolerance thereof, conventionally described in API 5L.

This explains why, in the current prior art, there are often difficulties in fitting the tube 220 in the collar 212.

In this case, the fit is virtually ensured owing to the radial expansion of the collar 212 and to the holding in place, with minimal deformation, of the corresponding end of the tube 220 whilst giving corresponding shapes to the collar 212 and to the end of the second tube 220. The possibility of dimensioning the tube 220 and the collar 212 in such a way that, when the actuating cylinders of the first support are retracted, the outer face of the wall of the tube 220 is in contact with the inner face of the collar 212 is also retained. In other words, the invention makes it possible to dimension the collar 212 and the tube 220 in such a way as to facilitate the mutual fixation thereof without impairing the fit.

Moreover, since the position of the rods 9 of the actuating cylinders 5 of the first support 110 and the position of the rods of the second support 120 relative to the reference shape are known, it is also possible to anticipate an impossibility of engagement, for example owing to a tube of which the dimensions would lie outside the tolerances.

Reference is now made to FIGS. 9 and 10, in which the first tube 210 and the second tube 220 are abutted, i.e. in their final state in the duct, positioned relative to one another.

The first tube 210 has retained its position from FIGS. 6 and 7, whereas the second tube 220 has been displaced in such a way that an end portion thereof is now arranged in the collar 212 of the first tube 210. A weld bead between the ridge at the base of the collar 212 and the end edge of the second tube 120 may now be made in order to make the join between these tubes tight and to hold them rigidly to one another. Prior to this welding procedure, the actuating cylinders 5 of the first support 110 are advantageously brought into their reference position so that the collar 212 is retracted to the smallest diameter thereof whilst retaining its shape. In this collar 212, the inner surface of the first tube 210 is then pressed against the outer surface of the second tube 220, thus ensuring a material presence, which is essential for subsequent fixation.

Compared to FIGS. 6 and 7, the first support 110, the second support 120 and the third support 130 have each retained their longitudinal position inside their respective tube.

The first tube 210 and the second tube 220 are shaped by contact over points. The resultant shape is a generally polygonal potatoid shape. Since these generally polygonal shapes are pseudo-homothetic and face one another, it is possible to connect them without having to compensate for a mismatch in shape between these end portions. This makes it possible to carry out automatic or semi-automatic fixing procedures, for example by welding, for example with the aid of mobile torches 330, the distance of which to the wall of the respective tube thereof, or the radial distance, may be controlled electronically. Further assembly methods can be used and are also improved thanks to the process described. It is also possible to provide neighbouring radial expansions over the collar 212 and over the end portion of the second tube 210 in order to carry out crimping, or else to heat one of the portions by induction so as to form a joint in the manner of a shrink fit.

Reference is now made to FIG. 11 to explain how the first support 110, the second support 120 and the third support 130 can be used to abut the first tube 210 and the second tube 220, i.e. to pass from the state shown in FIGS. 6 and 7 to that shown in FIGS. 9 and 10.

Firstly, the position and operational state of each of these supports is checked during a procedure 1100. During this procedure 1100, particular checks are made of the longitudinal position of each of the supports relative to the respective tube thereof, the angular position of the first support 110 relative to the second support 120, and the inclination of the supports relative to the inner surface of the tube, also known as “squaring” in the field. The angular position of each of these supports relative to the respective tube thereof may also optionally be checked. It is also checked that the actuators 5 of the first support 110, of the second support 120 and of the third support 130 are in their working state, i.e. that their respective rods are each in the working position.

During a procedure 1110, the first tube 210 or the first support 110 is immobilised. This immobilisation may be immediate owing to the weight of the section of duct already placed in position, or may require a specific blocking operation, for example by pouring concrete or by using worksite vehicles, for example of the bulldozer type.

During a procedure 1120, the third support 130 is pulled in such a way that it is brought towards the first support 110 until the second tube 220 penetrates the collar 212 of the first tube 210. The actuators via which the first support 110 is connected to the third support 130 are preferably used, for example the tensioners 310 of FIGS. 6 to 8.

The end portion of the second tube 220 must penetrate the collar 212, since:
the first tube 210 is radially expanded in the vicinity of the collar 212 thereof, whereas the second tube 220 has a diameter close to the nominal diameter thereof at its corresponding end portion;
the potatoid shape conferred to the first tube 210 is pseudo-homothetic and opposes the potatoid shape conferred to the second tube 220.

If the end face of the second tube 220 is inclined significantly relative to the plane normal to the longitudinal axis of the second tube 220, it is possible to pivot the second tube 220 so as to correct the inclination of the end face thereof in order to rectify the defect of shape and provide good fixing conditions, in particular a good positioning of the end edge of the second tube 220 relative to the welding ramp. The pivoting may result in a differential actuation of the tensioners 310.

Next, during a procedure 1130, the first tube 210 and the second tube 220 are connected, for example by forming a weld bead between the terminal edge of the second tube 220 and the inner surface of the first tube 210 in the vicinity of the collar 212. This makes it possible to ensure both the fixing of the tubes 210 and 220 to one another, and the tightness of the interior space thereof.

By immobilising the second tube 220 rather than the first tube 210 in the step 1120, it is possible to engage the collar 212 on the end of the second tube 220 by pulling the first support 110 onto the third support 130.

It will now be explained how the first support 110 and the second support 120 can be matched. In other words, the provision of a pair of equivalent supports will now be described.

Generally, a common reference for a pair of supports, of the type of the support 1, is taken from a single tube which will be used as a model. This model tube is one of the tubes for the duct to be formed or at least an equivalent tube, i.e. having the same nominal dimensions and tolerances. This procedure will be referred to hereinafter as “calibration”, although it differs considerably from conventional calibration procedures within the field which generally consist in passing a gauge through the inside of a tube.

A first of these supports is penetrated inside the model tube and the actuating cylinders 5 which equip it are in the rest position. The longitudinal position of the support in the model tube is checked. A good inclination of the frame relative to the inner surface of the model tube is ensured. The actuating cylinders 5 are controlled in such a way that their rods are displaced radially, step by step, becoming distanced from the frame until reaching a position in which the ends of these rods are each in contact with the inner surface of the model tube. With each advance, the longitudinal force on each rod 9 is noted and it is checked whether this is greater than the frictional forces within the actuating cylinder 5. If so, it is deemed that the end of the rod in question is in contact with the inner surface of the model tube. If not, the movement of extension is continued for this rod. In a variation, it is also possible to choose to stop this movement if a previously set level of force is reached.

When all the actuating cylinders 5 of the support are in contact with the inner surface of the tube, these actuating cylinders are retracted over the same path. The actuating cylinders are then in a reference position. Data relating to said position of the actuating cylinders can be stored.

In an equivalent manner, the other support is then calibrated with the aid of the same model tube by positioning the second support identically in said model tube (longitudinal position and squaring) and by applying the same path of retraction to each of the actuating cylinders 5 of the second support as was applied to the actuating cylinders 5 of the first support.

Reference is now made to FIG. 12 in order to explain how the actuating cylinders 5 are controlled during the phase of calibration of a support.

In a procedure 1200, the actuating cylinders 5, denoted generically by Act[i], are each in a respective rest position denoted RstPos.Act[i]. The position of the rod 9 which corresponds to the respective rest position may vary from one actuating cylinder 5 to another. The reference symbol i denotes a value from 1 to n, n corresponding to the number of actuating cylinders which equip the support. The support rests on its system of feet.

In a procedure 1210, the actuating cylinders 5 are controlled in such a way that their rods are displaced respectively by the same length, DeltaStrk. The usual position corresponds to the previous position increased by the extension DeltaStrk. The extension in question typically corresponds to an impulse sent to the solenoid valve powering the respective actuating cylinder 5.

In a procedure 1220, a value of longitudinal force on the rod 9 is acquired for each actuating cylinder 5, which value is denoted Ld.Act[i]. For each actuating cylinder Act[i], it is tested whether the force value Ld.Act[i] is less than a minimum value of contact force CtcLdmin.

The value CtcLdmin may be set previously. For example, this value CtcLdmin may be set at 3 kilonewtons. This value may be modified slightly for some actuating cylinders if these have an inner friction which is significantly different from the other actuating cylinders.

Insofar as it should correspond to a contact with minimal force, the value CtcLdmin may also be deduced from the development of the force on each of the rods. It is thus possible to establish that this value CtcLdmin is reached as soon as the force value Ld.Act[i] is considerably greater than the force values previously measured. These previously measured values are typically basically constant and correspond to the frictional forces in the actuating cylinder 5.

In either case the value CtcLdmin may differ from one actuating cylinder to another so as to take into account, or as a result of, frictional forces which may potentially differ from one actuating cylinder 5 to another.

If the ends of the actuating cylinders are equipped with a rotatably mounted roller, a better distribution of forces over the entire support is obtained, the support thus being able to withstand a slight displacement relative to the inner surface of the tube. In other words, the support positions itself inside the tube.

In a procedure 1230, if the force value Ld.Act[i] of a specific actuator Act[i] is less than the minimum force value CtcLdmin, a displacement of the rod 9 thereof is controlled by the value of the step in a direction of expansion. The test of procedure 1220 is then restarted.

If the test of procedure 1220 is positive for all the actuating cylinders, it is then tested for all these actuating cylinders that the force Ld.Act[i] is less than a maximum value of the contact force CtcLdmax during a procedure 1240. If not, the corresponding actuating cylinder is controlled during a procedure 1250 in such a way that the rod thereof retracts by a value of the step DeltaStrk and the test of procedure 1240 is repeated.

The value CtcLdmax may differ according to the choice of CtcLdmin. For example, CtcLdmax may be set to be greater than a given value of CtcLdmin, typically 500 newtons. If CtcLdmin is deduced from the development of the force on the rod of the actuating cylinders, CtcLdmax can also be set in this manner. CtcLdmax may then differ from one actuating cylinder 5 to another.

If a force on rod between CtcLdmin and CtcLdmax is measured for all the actuating cylinders 5, the rods 9 of all the actuating cylinders are retracted by the same value of path Strk during a procedure 1260.

The current position of the rods constitutes a respective reference position RefPos.Act[i], which may be stored if necessary during a procedure 1270.

With regard to calibration, in this case it involves taking a reference shape over the model tube, this reference shape corresponding to a state of stress of the model tube. A correspondence between a position of all the rods 9 (a reference position) and a specific potatoid appearance of the model tube has been obtained, at least at the support. This avoids having to refer back to a benchmark tube which has been machined precisely. This also makes it possible to dispense with precision machining of the supports which are subsequently matched.

Reference is now made to FIG. 13 in order to explain how the actuating cylinders 5 of a support are controlled in order to obtain an engagement such as that of the first support 110 of FIGS. 6 to 8.

In an initial optional procedure, in this case 1300, each actuating cylinder 5 is in its rest state, i.e. the position of its rod corresponds to the rest position RstPos.Act[i].

During a procedure 1310, each of the actuating cylinders Act[i] is controlled in such a way that it reaches its reference state, i.e. its rod is located in the reference position RefPos.Act[i].

In a procedure 1320 each of the actuating cylinders Act[i] is controlled in such a way that its rod is displaced in expansion by the value of the step DeltaStrk. The rods of all the actuating cylinders are displaced by the same distance from their respective reference position.

In a procedure 1330, it is tested whether the accumulated value of longitudinal force Ld.Act[i] on the rod of the actuating cylinders 5 is greater than a value of minimum load EngLdmin.

If the actuating cylinders 5 are all in a state such that the longitudinal force on their rods is greater than EngLdmin then the procedure is stopped. The actuating cylinders are then in their working state (procedure 1340).

If not, during the procedure 1320 each actuating cylinder is controlled in such a way that its respective rod is displaced in expansion by the value of the step DeltaStrk. The test of procedure 1330 is restarted.

The value of EngLdmin may be selected in different ways. For example, it may be selected so as to form a minimum engaging contact. In this case its estimation takes into account the coefficients of friction between the inner surface of the tube and the end of the rod 9, and between the outer surface of the tube and its support, as well as the weight of the tube. By way of first approximation, this minimum load EngLdmin can be calculated as being equivalent to the weight of the tube.

In accordance with an advantageous variation, the value of EngLdmin is determined so that the stresses exerted on the tube are close to the yield strength of this tube. For example, this yield strength may be estimated by finite element analysis. A significant radial extension of the tube is thus obtained which makes it possible to resiliently expand the collar 212, for example so as to facilitate the engagement of the second tube 220. According to the applications and the specifications, the value EngLdmin may be selected so as to ensure that the stresses exerted on the tube remain below the yield strength or so as to make it possible to slightly exceed this yield strength. In very specific applications it is possible to exceed this yield strength by quite a large extent.

In a variation, the test of procedure 1330 may be carried out for each actuating cylinder: if the test is negative for one of the actuating cylinders the procedure 1320 which includes all the actuating cylinders is restarted. In this variation the value EngLdmin is associated with one actuating cylinder. For example, it may then be obtained by dividing the overall value established as before by the number of actuating cylinders.

Although not indicated, it is checked at the same time that none of the actuating cylinders fails to withstand a force greater than a maximum force value and/or that the cumulative force does not exceed a maximum value of cumulative force, these values being determined on the basis of the yield strength of the tube as determined from these nominal dimensions, for example.

Reference is now made to FIG. 14 to explain how the actuating cylinders 5 of a support are controlled so as to obtain a shaping such as that of the second support 120 of FIGS. 6 to 8.

In an initial procedure 1400, each actuating cylinder 5 is in its rest state RstPos.Act[i]. This procedure is optional.

During an operation 1410 each of the actuating cylinders Act[i] is controlled in such a way that its rod reaches its reference position RefPos.Act[i].

In a procedure 1420 it is tested whether the cumulative value of the longitudinal force Ld.Act[i] on all the actuating cylinders is greater than a minimum value of contact CtcLdmin.

If not, each actuating cylinder is controlled (procedure 1430) in such a way that its respective rod is displaced in extension by the value of the step DeltaStrk. The test of procedure 1420 is restarted.

If yes, it is tested in a procedure 1440 whether the cumulative value of the longitudinal force Ld.Act[i] on all the actuating cylinders is greater than a maximum value of contact CtcLdmax. If yes, each actuating cylinder is controlled (procedure 1450) in such a way that its respective rod is displaced in retraction by the value of the step DeltaStrk. The test of procedure 1440 is restarted.

If the actuating cylinders 5 are all in a state such that the cumulative force is greater than CtcLdmin and less than CtcLdmax then the procedure is stopped. The actuating cylinders are then in their working state.

Such a control sequence ensures that the corresponding portion of the tube is shaped in the manner of the model tube or, failing that, has a pseudo-homothetic shape.

With a view to forming a duct from a plurality of similar tubes, the mutual pre-positioning of the first tube 210 and of the second tube 220 in the duct as is shown in FIGS. 6 to 8 will now be discussed.

Reference is first made to FIG. 15, which relates to the situation in which the first tube 210 and the second tube 220 correspond respectively to the tube initially placed in the duct and to a tube adjacent to said initial tube, or else when a pre-existing duct is extended.

A procedure 1500 in which a pair of supports of the type of the support 1 are calibrated is first carried out in order to obtain a pair of equivalent supports. The actuators of said first support are then controlled in their reference state.

After the calibration procedure 1500, an additional support is provided during a procedure 1520.

The additional support may be similar to the supports of step 1500. The additional support may also differ from these supports, for example by the actuators which equip it.

One of the equivalent supports is penetrated inside a tube during a procedure 1530, and the other of the equivalent supports is penetrated inside another tube during a procedure 1540. The additional support is penetrated inside one of the tubes receiving the equivalent supports during a procedure 1550. The tube housing merely one support is then installed in its final position in the duct during a procedure 1560. This tube may be described as the “initial tube”. Typically, this installation includes the positioning, with the aid of one or more worksite machines, of the tube and its support in the base of a trench or in the tunnel until it rests on a pair of battens, rails or the like. Alternatively, the tube initially housing two supports could be installed first.

The other tube, together with the other of the equivalent supports and the additional support, is then installed beside the initial tube. The ends of the initial tube and of the adjacent tube are arranged virtually opposite and at a distance from one another. It is ensured that the primary planes of the end plates are perpendicular to the inner surface of the tube (squaring). This corresponds to the procedure 1570.

After this phase of positioning of the supports, it is possible to fit the initial tube and the additional tube one inside the other, place the inner surface of one in contact with the outer surface of the other and join them together.

Reference is made to FIG. 16, which now relates to the situation in which the first tube 210 and the second tube 220, as shown in FIGS. 6 to 8, correspond respectively to the leading tube of a duct portion in position and an additional tube to be positioned so as to follow on from said duct portion.

During a step 1600, the positioning of the first support 110, of the second support 120 and of the third support 130 is checked. It is checked that this positioning corresponds to that described in relation to FIGS. 6 to 8, the second tube 220 then corresponding to the leading tube of the duct portion in position.

During a procedure 1610, an additional tube is provided which is similar to the tubes already placed in the duct.

During a procedure 1620, the additional tube is installed in the vicinity of the leading tube, such that they are mutually opposed. The additional tube and the leading tube are arranged in a mutual position which corresponds to their pre-positioning in the duct.

During a procedure 1630 the second support 120 and the third support 130 are displaced from the leading tube as far as the additional tube until they reach their longitudinal position in the additional tube. The wheels 11 of each of these supports facilitate this displacement, rolling against the inner surface of the leading and additional tubes.

During a procedure 1640 the first support 110 is displaced from the tube in position in the duct, which tube is adjacent to the leading tube, as far as the leading tube itself until the first support 110 reaches its working position relative to the leading tube.

An entire duct is deployed by first positioning an initial tube and an adjacent tube in a duct portion and then by positioning additional tubes repetitively, in each case on the tube in position at the head of the duct. Each time, the positioning of the tubes includes the pre-positioning thereof in the duct and the positioning thereof, in this case by engagement of one tube in another.

Reference is now made to FIGS. 17 to 21, which show a variant embodiment of the invention.

Compared to FIGS. 6, 7, 9 and 10, it is to be noted that there is no third support 130. The first support 110 and the second support 120 retain their position relative to the first tube 210 and to the second tube 220.

The actuating cylinders 5 of the first support 110 carry out processes of engaging contact and shaping with strong radial deformation, whereas the actuating cylinders of the second support carry out processes of engaging contact and shaping with minimal expansion. This embodiment is advantageous when the dimensional tolerances of the collar have been controlled sufficiently to be sure that the engagement can take place. A conical collar may also be provided so as to allow greater tolerances.

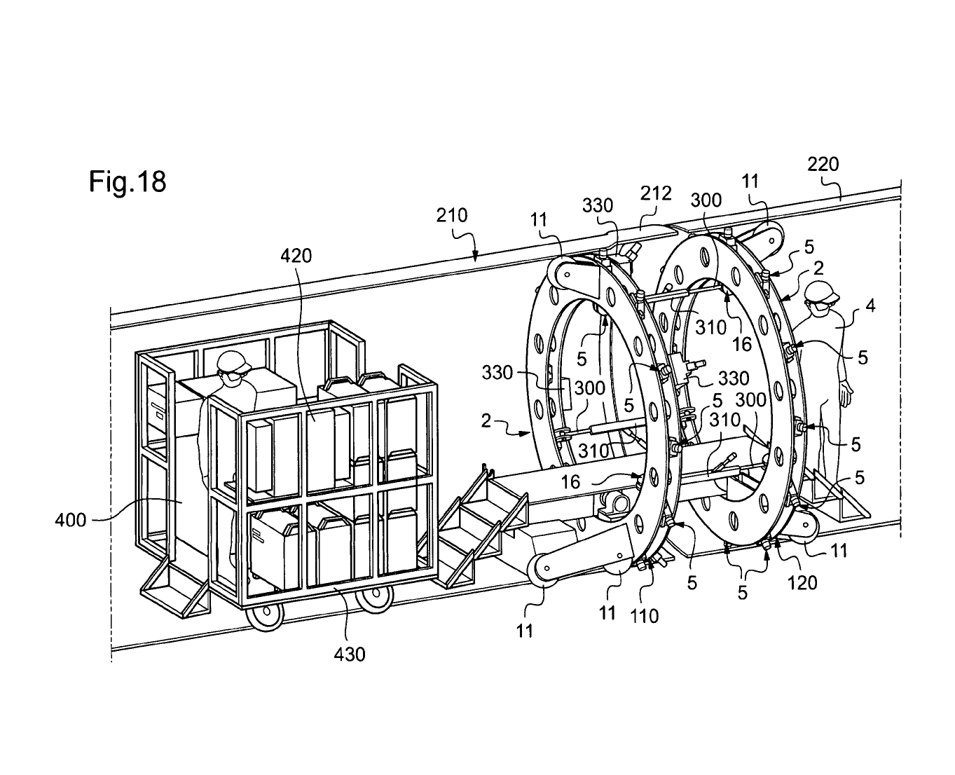

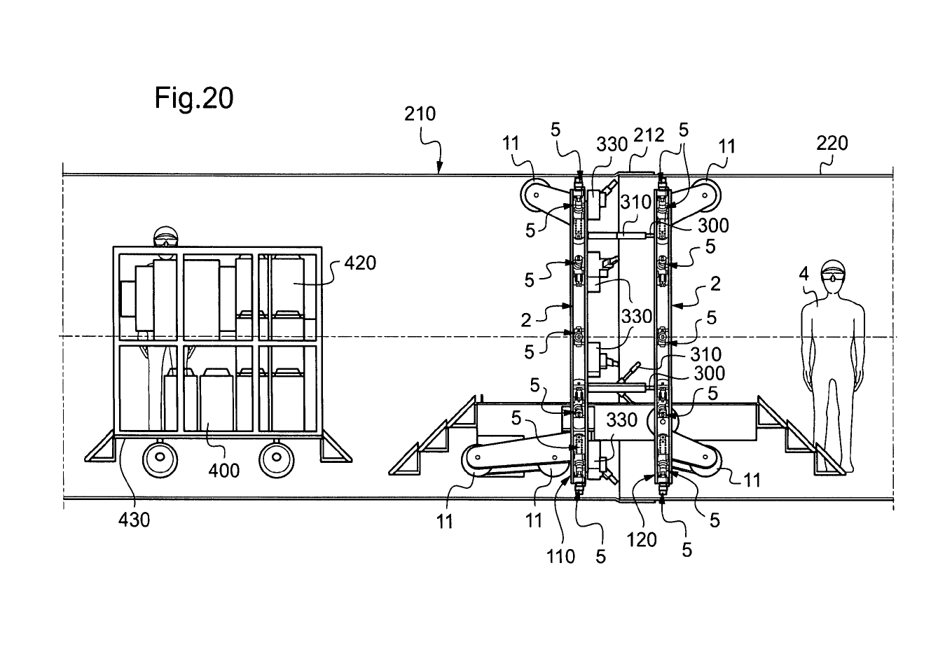

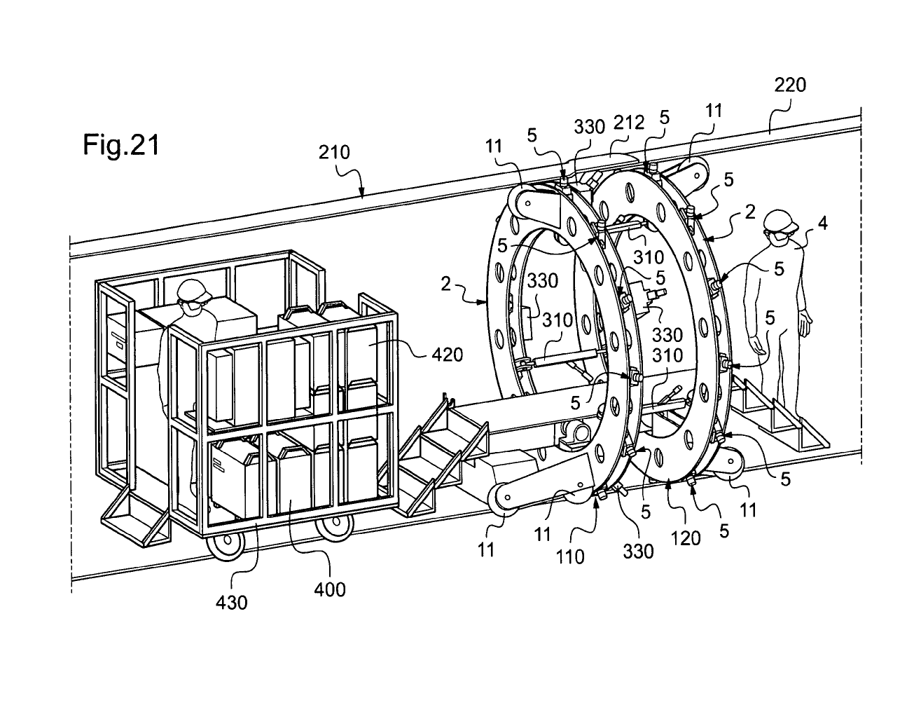

In order to pass from the pre-positioned state of FIGS. 17 and 18 to that of FIGS. 20 and 21, the second support 120 is pulled with the second tube 220 onto the first support, which remains stationary. The connection between the first support 110 and the second support 120 is similar to that of the first support 110 and of the third support 130 in FIGS. 6, 7, 9 and 10.

A device and a method for abutting tubes of large diameter and low thickness have been described. Two supports are used which are each equipped with actuators mounted on a common frame so as to displace a mobile portion in the same plane, by projection from the frame, with control of the forces and of the displacement of this mobile portion. These actuators are mounted on the frame of their respective support in an equivalent manner, i.e. there is at least one relative position of the supports in which each actuator of a support is positioned opposite an actuator, optionally of the same type, its counterpart, of the other support.

The invention therefore discloses that actuators are first used to shape the ends of tubes to be correspondingly abutted, that is to say to shape these ends as a function of the other in such a way that they are ultimately shaped so as to enable their mutual fixation (matching shapes). The adjacent ends of a first tube and a second tube can be respectively shaped according to a first shape and a second shape that match one another. Then, the adjacent ends of the second tube and a third tube can be respectively shaped according to a third shape and a fourth shape that match one another. The second shape does not necessarily match the third shape.

The actuators are then used to take the references of a model shape, originating from a tube, this reference being common to the two supports. These supports are then used to shape the corresponding ends of the tubes to be abutted, in accordance with pseudo-homothetic shapes.

The reference positions of the actuating cylinders 5 are established jointly for all of the actuating cylinders of a support from the same shape.

The invention affords a specific advantage with tubes equipped with an end portion in the form of a collar. Owing to manufacturing tolerances, it is in fact common for the process of fitting the additional tube in the collar to require the involvement of operators, equipped with tools of the crowbar type, who force the end of the additional tube into the collar, thus correcting any defects of shape of these tubes in their end portion by a series of local deformations.

These procedures accompanied by welding procedures may typically require a number of days' work by several operators.

According to the Applicant's estimations, the invention makes it possible to position and assemble an additional tube on the end tube of a tube duct within a few hours, or half a day at most.

However, the invention is not limited to tubes with a collar. It can advantageously be implemented when abutting the ends of two tubes edge to edge. In this case, the actuating cylinders of the first support 110 are jointly controlled, from their reference position, in such a way that a minimum engaging contact is produced, shaping the end of the first tube, whereas the actuators of the second support 120 are actuated identically so as to correspondingly shape the end of second tube. The pulling actuators are used to correctly position side by side the proximal ends of the tubes to be abutted. In a variation, a third support and a fourth support may be brought into engaging contact, far from the first and second supports, with a respective tube, mounted one on the other with relative sliding so as to bring together the mutually opposite edges of the first and second tubes.

The invention is not limited to the embodiment described above, merely by way of example, but encompasses all variations which may be conceived by the person skilled in the art.

In particular, the third support may differ widely from the first support 110 and from the second support 120 provided it is able to engage with the inner surface of the second tube. In a practically minimalistic form, the third support comprises a single actuator connected to two shoes which can be displaced relative to one another in opposite directions. In such a case the shoes are angular, which makes it possible to press rather broadly over this inner surface so as to avoid a significant local deformation, which could also affect the end of the second tube.

Although an assembly of similar tubes has been described, the invention also covers the abutment of tubes which are of different shapes but are compatible with one another. For example, it may be desired to join in succession tubes having two collars with tubes having no collar. In this case the expanded support will preferably be arranged in the vicinity of a collar.

The similarities and compatibilities between the tubes primarily relate to their cross-section, since the abutted tubes may have a different length from one another, without modifying the method described above.

Owing to the step of matching the supports, in particular by calibration from the same tube, the supports can be manufactured in a greatly simplified manner since it is not necessary to revert to precision machining of large parts. In fact, as described, the supports have a fabricated structure which can be produced economically and is particularly effective, robust, light, low-cost and practical.

Insofar as the supports 110 and 120 make it possible to hold the first tube 210 and the second tube 220 firmly in place, in particular during the fixing procedures, they can be considered to be flanges.

The frames which support the actuators may be modified so as to be used outside parts to be abutted by mounting the actuators in such a way that their respective rod projects towards the inside of the end plates in the form of rings. The abutment process is implemented similarly, the different contacts projecting from the outside of the tubes. Such a device may be coupled to a similar device inside the parts to be abutted so as to form what are known as “X” welds, i.e. welds comprising inner and outer weld beads facing one another.

The abutment process is not limited to tubes, but applies to any parts having end portions in the form of hollow profiles, for example a tank comprising a hemispherical base part and a cylindrical body part, or else structural parts in the form of profiles.

The portions to be abutted may be polygonal. In this case, it may be advantageous to shape the end plate supports homothetically to this polygonal shape.

The number of actuators per frame may vary compared to that described above. It is preferable to provide at least three actuators per support. The number of additional actuators may also vary. This number is advantageously between three and six. If six actuating cylinders are provided, these may be arranged so as to form what is known as a hexapod positioner or a “Stewart platform”, which makes it possible to compensate for virtually any defect of mutual positioning between the end faces of the first and second parts.

The mutual fixing of the tubes is not necessarily performed with contact between the surfaces of these tubes, but may involve the insertion of an additional part, of a flange and/or sleeve type, optionally equipped with a seal.

The joining method may be used with parts having very different thicknesses.

Compared to the prior art, in particular represented by FR 2 887 164 and the similar systems, the invention has the following features:
each support comprises a number of actuators, each capable to generate a movement or a force from input energy;
each actuator can be controlled independently of the others, which makes it possible to shape the ends of the parts in accordance with complex shapes which are not necessarily circular, thus producing shapes which are compatible with one another with minimal deformations;
the shape of the ends of the parts to be abutted is not set in advance owing to the shape of the support;
the actuators mounted on one of the supports can be controlled independently of the actuators of the other supports; and each actuator is controlled as a function of the force which is exerted longitudinally over its rod;
the frames, and consequently the parts that they carry, may be brought towards one another from considerable distances apart;
the frames are brought towards one another in accordance with a movement which is not necessarily purely translational, in such a way that it is also possible to compensate for defects in inclination (squaring) of the end faces of the parts;
the frames and their actuators may be supplied on-site in the form of a kit;
the openwork structure of these frames allows users to pass through them and makes them lightweight;
these frames do not require precision machining, which results in substantially lower production costs; and these frames are not rigidly interconnected, which makes it possible to pivot them relative to one another during the phase in which they are brought towards one another.

1-23. (canceled)

24. A method for abutting parts formed, at least in part, as hollow profiles, the method comprising:
a) providing first and second actuators, each comprising a mobile portion, the first actuators being mounted on a first common frame such that their respective mobile portions can move in a common plane by protruding from the first frame, the second actuators being mounted on a second common frame in an equivalent manner to the first actuators;
b) positioning the first frame in an end region in a form of a hollow profile of a second part and positioning the second frame in an end region in a form of a hollow profile of a second part such that equivalent actuators of the first and second frames are mutually opposed;
c) controlling the first actuators and the second actuators to displace the mobile portions thereof into respective working positions in which the mobile portions of the first actuators exert forces on a wall of the first part whilst the mobile portions of the second actuators exert forces on a wall of the second part respectively, so that an end region of the first part and an end region of the second part match one another;
d) fixing the first part and the second part to one another at their respective end regions.

25. A method according to claim 24, wherein the c) controlling the first actuators and the second actuators includes:
c1) controlling each of the first or second actuators such that the mobile portion thereof is in a respective starting position;
c2) for each first actuator or each second actuator, measuring a force value over the respective mobile portion thereof;
c3) evaluating a displacement control condition of the first actuators or of the second actuators on the basis of a comparison of the measured force values with one or more target force values;
c4) if the displacement control condition is verified, controlling the corresponding actuators so as to displace the respective mobile portions thereof by a same distance;
c5) repeating c2) to c4) until the displacement control condition is no longer verified.

26. A method according to claim 25, wherein the c3) evaluating the displacement control condition includes a comparison of a total value of the measured force values with a target force value.

27. A method according to claim 25, wherein in the c3) the evaluation of the displacement control condition includes a comparison of each measured force value with a target force value.

28. A method according to claim 25, wherein in the c4) controlling the actuators, a direction and/or distance of the controlled displacement are determined as a function of the comparison of measured force values and target force values.

29. A method according to claim 25, wherein at least some of the target force values are determined as a function of yield strength of the first part and/or of the second part in the respective end regions thereof.

30. A method according to claim 25, wherein the target force values correspond to an engagement of the first and/or second actuators with the wall of the first part and/or of the second part respectively.

31. A method according to claim 25, wherein in the c) controlling the first actuators and the second actuators, the forces exerted by the first actuators are greater than or equal to a force of engagement, and wherein the d) fixing the first part and the second part to one another includes:
d1) pulling the second part so as to rest on the first frame;
d2) abutting the second part against the first part;
d3) connecting the first part to the second part, at least in the respective end regions thereof.

32. A method according to claim 31, wherein in the c) controlling the first actuators and the second actuators, the forces exerted by the second actuators are greater than or equal to a force of engagement, and wherein the d1) pulling the second part includes:
d11) connecting the second frame to the first frame with a possibility of relative displacement under action of additional actuators, the displacement including at least one component of translation in a direction substantially perpendicular to at least one of the common planes of displacement of the mobile portions of the first actuators and of the second actuators;
d12) controlling the additional actuators such that the second frame and the second part are pulled relative to the first frame and the first part.

33. A method according to claim 31, wherein the d1) pulling the second part includes:
d11) providing third actuators each including a mobile portion, the third actuators being mounted on a third common frame such that their respective mobile portions can be displaced by projecting from the third frame;
d12) positioning the third frame in the second part so as to be distanced from the end region thereof compared to the second frame;
d13) controlling the third actuators as far as a working position in which the third actuators engage with the wall of the second part;
d14) connecting the third frame to the first frame with a possibility of relative displacement under action of additional actuators, the displacement including at least a component of translation in a direction substantially perpendicular to at least one of the common planes of displacement of the mobile portions of the first actuators and of the second actuators;
d15) controlling the additional actuators such that the third frame and the second part are displaced relative to the first frame and the first part.

34. A method according to claim 24, wherein in the c) controlling the first actuators and the second actuators, the forces exerted by the second actuators are close to a simple contact force.

35. A method according to claim 24, wherein the end region of either the first part or the second part is shaped in a form of a collar, wherein in the c) controlling the first actuators and the second actuators, the forces exerted by the mobile portions of the first actuators or second actuators are established as a function of yield strength of the end region shaped in the form of a collar, whereas the forces exerted by the mobile portions of the respective other of the first actuators and second actuators correspond to a simple contact force.

36. A method according to claim 24, wherein the a) providing first and second actuators includes:
a1) the first actuators being mounted on the first frame, establishing a reference position for each of them based on a contact position in which their mobile portions each exert a first value of force on the wall of a model part;
a2) the second actuators being mounted on the second frame, establishing a reference position of their mobile portion for each of them based on a contact position in which the mobile portions exert a force of equal value to the first value of force on the wall of the model part;
and wherein in the c) controlling the first actuators and the second actuators, the mobile portions are displaced jointly from their respective reference position.

37. A method according to claim 36, wherein the first force value corresponds to a simple contact with the wall of the model part.

38. A method according to claim 36, wherein in the c) controlling the first actuators and the second actuators, the first actuators and/or the second actuators are displaced jointly, step by step, from their reference position.

39. A method according to claim 36, wherein the reference position of the first and/or the second actuators corresponds to a displacement of retraction from their respective contact position, the value of the retraction being substantially equal for all of the first actuators and/or the second actuators.

40. A method according to claim 24, wherein in the c) controlling the first actuators and the second actuators, the end region of the first part and the end region of the second part are shaped pseudo-homothetically to one another.

41. A method according to claim 24, wherein the first part includes a leading tube of a duct formed of tubes, whereas the second part includes an additional tube.

42. A method according to claim 24, wherein the first actuators and the second actuators can be controlled individually and independently from each other.

43. A kit forming a device for implementing the method according to claim 24, comprising first and second actuators each including a mobile portion, a first frame and a second frame, the first actuators being mounted on the first frame such that their respective mobile portions can be displaced in a common plane so as to project from the first frame, the second actuators being mounted on the second frame in an equivalent manner to the first actuators on the first frame.

44. A kit according to claim 43, further comprising a memory storing, for each of the first actuators, a reference position of the mobile portion thereof corresponding to a first value of force on the wall of a model tube, and for each of the second actuators a reference position corresponding basically to the first force value of the corresponding first actuator.

45. A kit according to either claim 43, further comprising third actuators each including a mobile portion, and a third frame, the third actuators being mounted on the third common frame such that their respective mobile portions can be displaced so as to project from the third frame.

46. A kit according to claim 43, further comprising at least one device for connecting, with relative displacement, the second frame or the third frame on the first frame, the mounting device including additional actuators, under action of which the second frame or the third frame can be pulled towards the first frame.
